(19) United States
(12) Patent Application Publication
(10) Pub. No.: US 2005/0076304 A1
(43) Pub. Date: Apr. 7, 2005

(54) Method and system for remote playback of a DVD

(75) Inventor: Honda Shing, Fremont, CA (US)

Correspondence Address: ROSENBERG, KLEIN & LEE, 3458 ELLICOTT CENTER DRIVE-SUITE 101, ELLICOTT CITY, MD, 21043, US

(73) Assignee: Intervideo, Inc.

(21) Appl. No.: 10/116,459

(22) Filed: Apr. 2, 2002

(51) Int. Cl. H04N 5/44

(52) U.S. Cl. 715/716

(57) ABSTRACT

The present invention provides techniques, including a system and method, for remote playback of a DVD. In an embodiment a remote playback system has some components of a DVD player software executing on at least one client device and other components on at least one server device. DVD control and navigation commands as well as presentation data are transferred between clients and servers. Thus users can control, navigate and playback DVD presentation data from a server device with a DVD drive on client devices located anywhere as long as they are connected to the server through a network.

### FIELD OF THE INVENTION

The invention relates generally to the field of optical storage players, and in particular to DVD software players.

### BACKGROUND OF THE INVENTION

Digital Video/Versatile Discs or DVDs are growing rapidly as the media for the storage of both Hollywood Movies and as a large capacity extension of the CD-ROM/CD-Audio format. In order to be able to play and view DVD video, using a computer system having a DVD drive, it is necessary to have some form of DVD player software installed. The DVD player software includes either a hardware or software decoder for decoding the movie data. A hardware decoder typically has a PCI plug-in card that is installed in the computer. These cards normally provide a Composite and S-Video output connection for viewing a movie on a conventional television with the appropriate video input connection facilities. A software decoder has software stored on the computer for decoding and typically requires a fast CPU, for example, an Intel® Pentium® processor with speeds over 450 MHz. As fast CPU computers become more and more common, software decoders are increasing in popularity.

FIG. 1 is a simplified block diagram of a DVD system of the prior art. A DVD 110, i.e., the physical disc, contains navigation data 112 and presentation data 114. The navigation data 114 allows the DVD to be randomly accessed by chapters and titles. The audio and video content data of what the user wants to see or hear, e.g., movie, is the presentation data 114. The navigation data 112 is used by the navigation manager 122 to select which part of presentation data 114 is read by the presentation engine 124. The navigation manager 122 and the presentation engine 124 are part of a DVD player 120. A user 130 inputs into the navigation manager 122 his/her choices and the navigation manager 122 directs the presentation engine 124 to get the chosen presentation data 114 from the DVD 110 via a DVD drive (not shown). The presentation data is decoded in the presentation engine 124 and is sent for display 132 to the user 130.

In the past a consumer DVD player was a standalone unit. Today with the many home personal computers (PCs), the DVD Drive is a part of the PC and the DVD player software 120 is stored on the PC's hard drive. The typical configuration is one DVD drive and one DVD player software per PC. The problem is that this typical configuration does not allow for a user to playback the DVD in the disc drive of another user's PC. The user needs his own copy of the DVD in his own disc drive.

Thus there is a need for techniques that allow better use of DVD resources, without requiring each computer to have a DVD drive and its own copy of a DVD in its own DVD drive in order to playback the presentation data on the DVD.

### SUMMARY OF THE INVENTION

The present invention provides techniques, including a system and method, for remote playback of a DVD or Video CD (VCD). In an exemplary embodiment of the present invention a remote playback system has some components of a DVD player (or VCD player) software executing on at least one client device, e.g., client computer, and other components on at least one server device, e.g. server computer. DVD (or VCD) control and navigation commands as well as presentation data are transferred between clients and servers. Thus users can control, navigate and playback DVD (or VCD) presentation data from a server device, having a DVD (or CD) drive, on one or more client devices located anywhere as long as they are connected to the server device through a network. In addition, a server device with a DVD (or CD) drive can support playback of the DVD (or VCD) presentation data on multiple client devices at the same time. Only the server device has the DVD (or VCD) in its DVD (or CD) drive. The client devices may or may not have DVD (or CD) drives. A server device includes, a server computer or a consumer product or a network device or any other electronic device that has a processor and a memory. A client device includes, a client computer or a consumer product or a network device or any other electronic device that has a processor and a memory. Access policies can be specified to allow one, many, or all the clients to control and to navigate the playback of the DVD (or VCD) presentation data. For example, a home network may have only one DVD drive that may be shared by the other PC's in the family or a business may share one DVD (or VCD) on a server device with a number of client devices on its network.

In an embodiment of the present invention a method for a first device remotely playing back a DVD (or VCD) at a second device is provided. The method includes receiving information, including DVD (or VCD) presentation data, from the second device. Next part of the DVD (or VCD) presentation data is decoded by the first device. And the part is processed for display.

Another embodiment of the present invention provides a method for providing presentation data from a first computer, including a DVD drive, to a second computer, including a GUI remote control. First, a command is received from the GUI remote control. Then the command is executed by a navigator module operating on the first computer, wherein the navigator module selects the presentation data. And the presentation data is encrypted before sending the presentation data to the second computer.

Yet another embodiment of the present invention provides a system for sending presentation data from a DVD drive at a server to a client. The system includes: a remote command handler for receiving a command from a graphical user interface; a navigator module for processing the command and selecting presentation data from the DVD drive; and a network encryption module for encrypting and sending the presentation data to the client via a communications network.

A client system for remote playback of a DVD at a server device by a client device connected to the server device via a communications network is provided as an embodiment of the present invention. The client system includes: a network decryption module for decrypting presentation data from the server device; a decoder for decoding part of the decrypted presentation data; and a display connected to the client device for displaying the part after decoding.

A system for remote playback of a DVD is provided as another embodiment of the present invention. The system includes: a server device and a client device. The server device includes: a DVD drive, DVD navigator software, and a network module for sending presentation data from the DVD drive, wherein the presentation data is selected by the DVD navigator software. The client device, for receiving the presentation data, includes a graphical user interface for accepting a playback command entered by a user to control the DVD navigator software in the server device; a demultiplexer for distributing a part of the presentation data to a decoder; and a display for displaying the part after decoding.

Yet another embodiment of the present invention has a system for providing both server and client functions for playback of a DVD or VCD. The system includes: a DVD drive for playback of the DVD or VCD by a local client or a remote client; a remote command handler for receiving commands from the remote client and sending commands to a remote server; a network interface module for receiving presentation data from the remote server; and a multicast module for sending presentation data from the DVD or VCD drive to one or more remote clients.

An embodiment of the present invention provides a home networking system for a user viewing on a display, connected to a client device at a first location, presentation data of a DVD or VCD loaded in a DVD or CD drive on a server device at a second location. The system includes: a home networking device connecting the server device to the client device via a communications link. The server device sends the presentation data from the DVD or VCD to the client device. And the client device decodes part of the presentation data for displaying on the display.

Another embodiment of the present invention includes a method for client devices playing back a DVD or VCD loaded in a DVD or CD drive of a server device. A playback command from one client device is received by the server device. Next, responsive to the playback command, presentation data is retrieved from the DVD or VCD and multicast to the client devices.

One aspect of the present invention includes a computer program product, having code stored on a computer readable medium, for providing presentation data from a first device, including a DVD drive, to a second device, including a GUI remote control. The code includes: code for receiving a command from the GUI remote control; code for executing the command by a navigator module operating on the first device, where the navigator module selects the presentation data; and code for encrypting the presentation data before sending the presentation data to the second device.

Another aspect of the present invention includes a computer program product, having code stored on a computer readable medium, for a first device remotely playing back a DVD at a second device. The code includes: code for receiving information, including DVD presentation data, from the second device; code for decoding part of the DVD presentation data by the first device; and code for processing the part for display.

These and other embodiments, features, aspects and advantages of the invention will become better understood with regard to the following description, appended claims and accompanying drawings.

### BRIEF DESCRIPTION OF THE DRAWINGS

FIG. 1 is a simplified block diagram of a DVD system of the prior art;

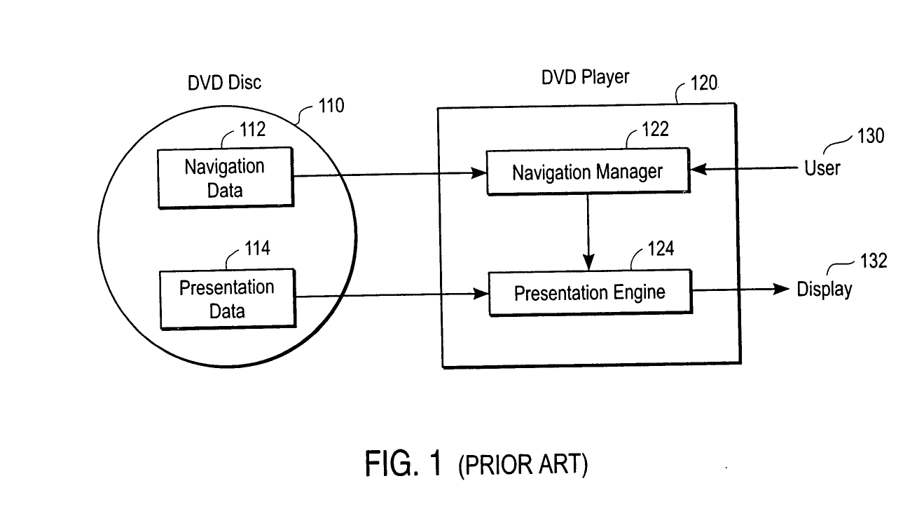

FIG. 2 is a block diagram of a DVD software player;

FIG. 3 is an example of a window showing DVD presentation data on a display screen of an aspect of the present invention;

FIG. 4 has an example of a remote GUI used for control and navigation of playback of a DVD of another aspect of the present invention;

FIG. 5 is a network diagram of a client server system of one embodiment of the present intervention;

FIG. 6 is a block diagram of modules on a server computer of one embodiment of the present invention;

FIG. 7 is a block diagram of modules on a client computer of an embodiment of the present invention;

FIG. 8 is a flowchart of the remote playback process of an embodiment of the present invention;

FIG. 9 is a block diagram of a software DVD player that has both client mode and server mode; and

FIG. 10 is a diagram of an example home networking system in which a DVD drive is shared by multiple users of an embodiment of the present invention.

### DETAILED DESCRIPTION OF THE INVENTION

In the following description, numerous specific details are set forth to provide a more thorough description of the specific embodiments of the invention. It is apparent, however, to one skilled in the art, that the invention may be practiced without all the specific details given below. In other instances, well known features have not been described in detail so as not to obscure the invention.

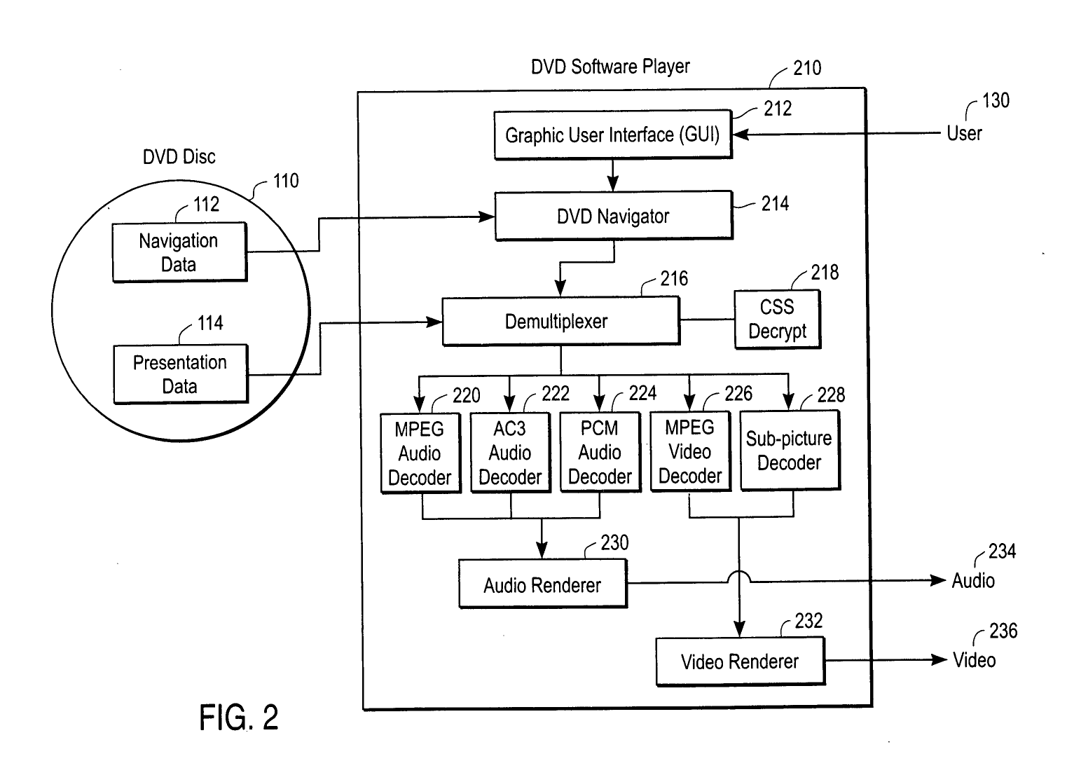

FIG. 2 is a block diagram of a DVD software player. The DVD software player 210 is connected to a DVD drive having DVD disk 110. A graphical user interface (GUI) 212 shown on a display accepts control and navigation playback commands from a user 130 and sends the commands to the DVD navigator 214. Responsive to the user playback commands, the DVD navigator 214 uses the navigation data 112 on the DVD disk 110 to select specific presentation data from the presentation data 114 on the DVD disk 110. The selected presentation data is sent to the demultiplexer 216. This selected presentation data may be Contents Scrambling System (CSS) encrypted and typically includes interleaved packets of video and audio presentation data. The demultiplexer 216 decrypts the CSS protection using a CSS decryption module 218 and filters out packets of a predetermined encoding type as specified by the DVD navigator 214. For example, the DVD navigator 214 may direct that only MPEG audio and MPEG video presentation data should be decoded. The demultiplexer 216 filters out from the selected presentation data only the MPEG encoded video and audio data and sends the MPEG data to the MPEG audio decoder 220 and the MPEG video decoder 226. The MPEG audio decoder then outputs its decoded data to an audio renderer 230 for playing the audio 234. The MPEG video data is sent from the MPEG video decoder 226 to the video render 232 to produce the video output 236. The audio output 234 and the video output 236 are displayed, for example, on a computer CRT with the accompanying sound on the computer's audio speakers. The demultiplexer 216 is also coupled to a AC3 audio decoder 222 (for Dolby sound), a PCM audio decoder 224, and a sub-picture decoder 228 (for additional picture information, e.g., subtitles). The MPEG audio decoder 220, AC3 audio decoder 222, and PCM audio decoder 224, are coupled with one or more audio renders, represented for simplicity by audio render 230. The MPEG video decoder 226 and sub-picture decoder 228 are coupled to one or more video renders, represented for simplicity by the video render 232.

The functions of an implementation of a conventional DVD software player are described in the “DVD Specifications for Read-Only Disc, Part 3, Video Specifications,” Version 1.0, Aug. 1996, Toshiba Corporation, Tokyo Japan. Since most of the details of the conventional DVD software player are known to one of ordinary skill in the art, they are omitted so as not to obscure the invention, e.g., a movie.

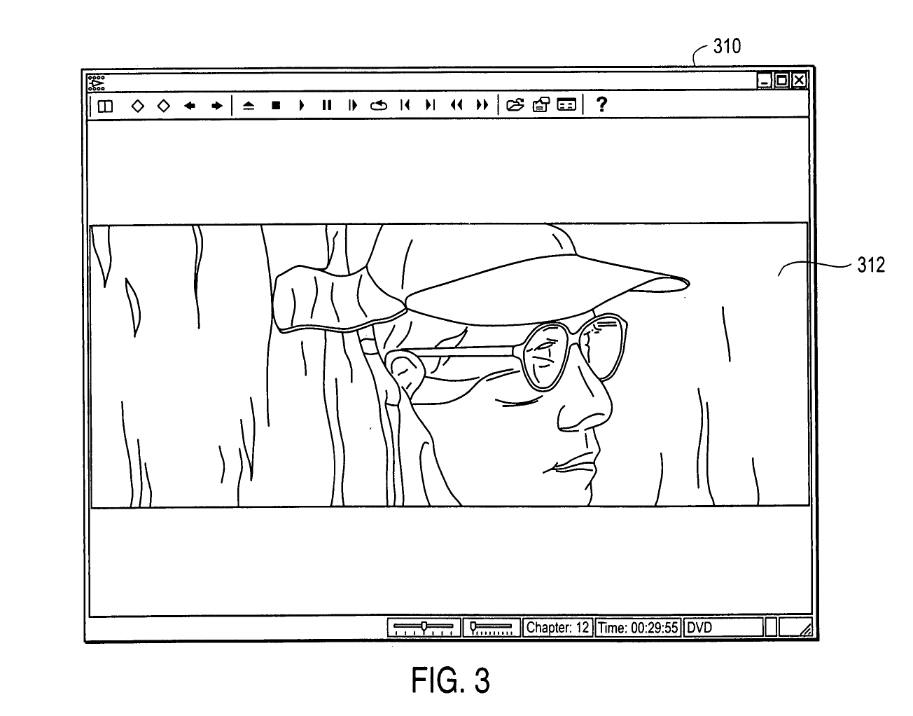

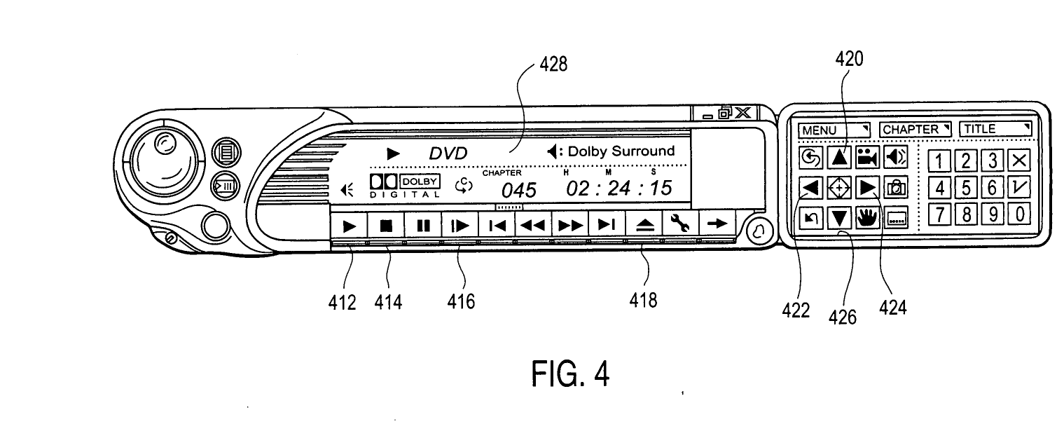

FIG. 3 is an example of a window 310 showing DVD presentation data 312, e.g., a movie, on a display screen of an aspect of the present invention. The window 310 may be shown on the server's or the client's or both displays. The playback of the DVD presentation data 312 is controlled by the user via a graphical user interface (GUI) shown in FIG. 4.

FIG. 4 has an example of a remote GUI used for control and navigation of playback of a DVD of another aspect of the present invention. The GUI includes buttons to control typical operation of the DVD drive, e.g., play 412, stop 414, pause 416, and eject 418, and navigation of presentation data, e.g. buttons 420, 422, 424, and 426. Also shown is an area 428 displaying status information on the DVD playback.

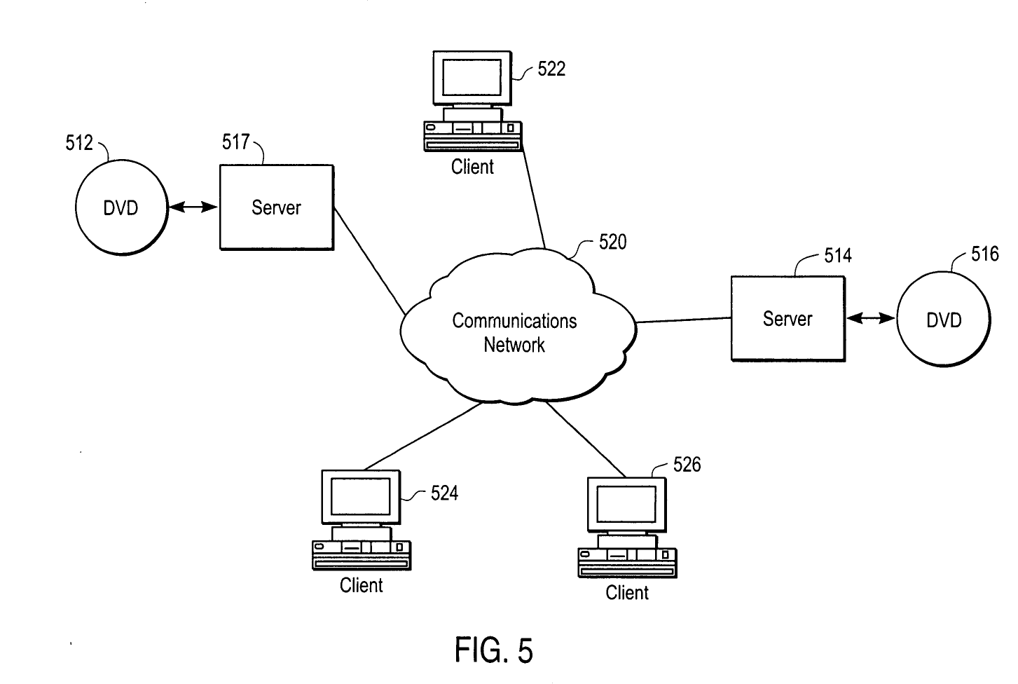

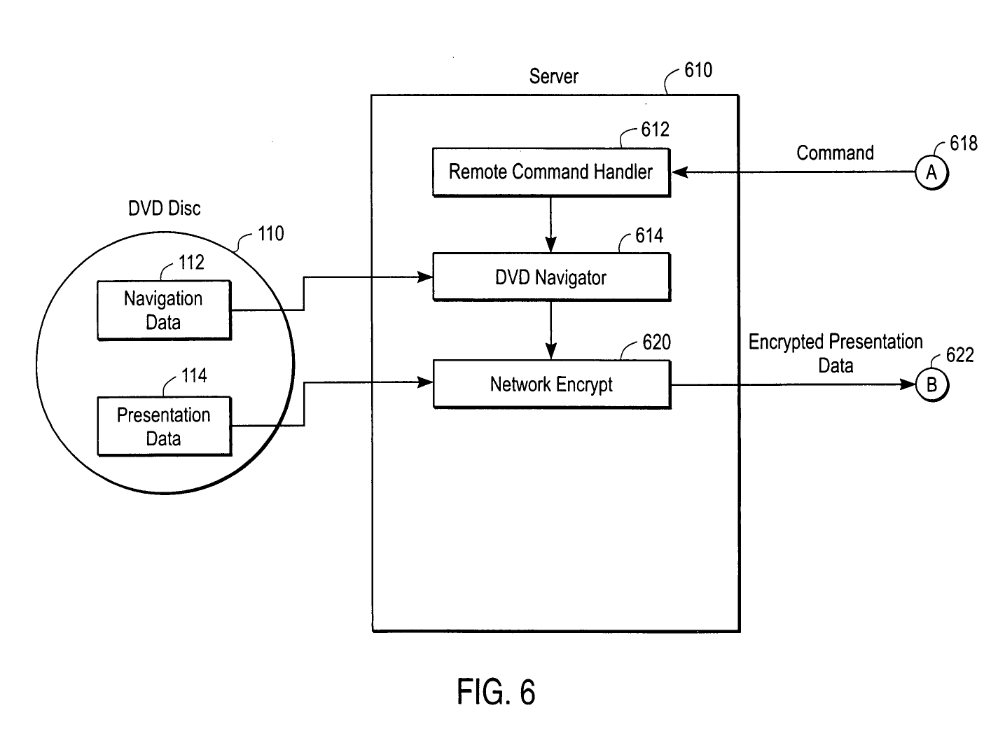

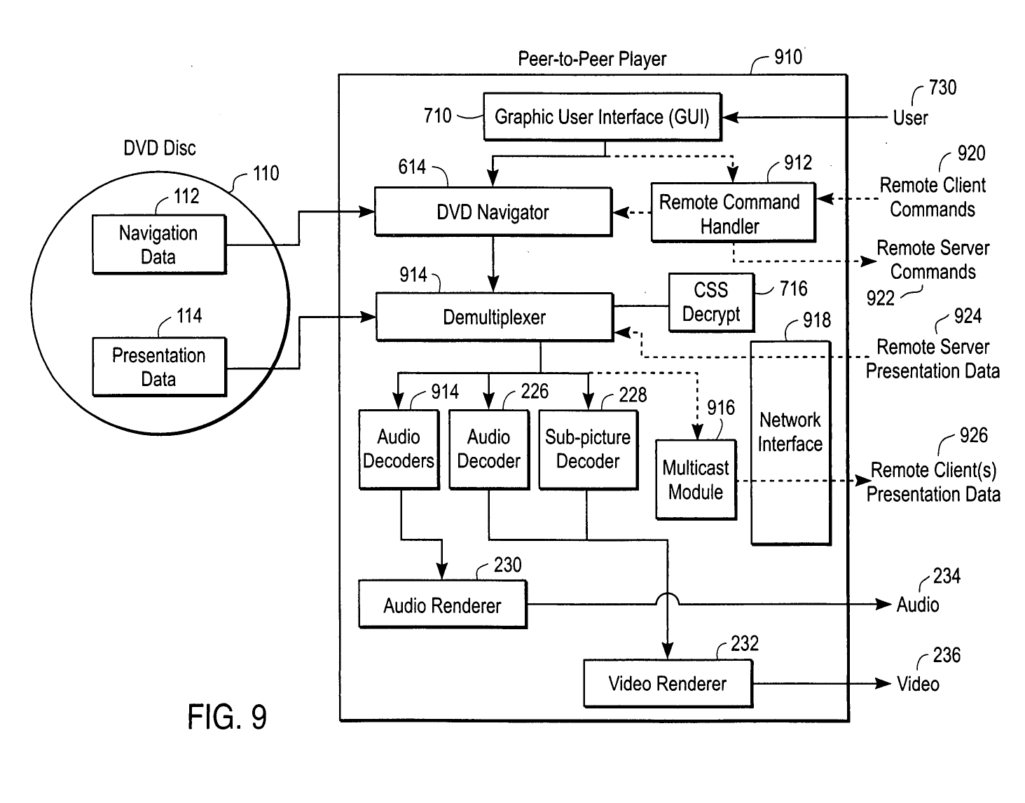

FIG. 5 is a network diagram of a client server system of one embodiment of the present intervention. A server computer has a DVD drive with a DVD, for example, server computer 510 has a DVD drive with DVD 512 and server computer 514 has a DVD drive with DVD 516. The servers are connected to a communications network 520 which also connects them to one or more client computers, for example, client computers 522, 524, and 526. A client computer is a computer that wants to access a DVD on a server computer and may or may not have a DVD drive itself. For example, client computer 524 can playback the DVD 512 on server computer 510 or the DVD 516 on server computer 514. In addition, server computer 510 may have a peer-to-peer software player (FIG. 9), which allows server computer 510 to playback the DVD 516 on server computer 514. Thus the peer-to-peer software player allows a server computer the option to perform as a client computer. FIG. 6 is a block diagram of modules on a server computer of one embodiment of the present invention. Server software 610 includes a remote command hander 612, a DVD navigator 614, and a network encryption module 620. The remote command handler 612 receives control and navigation playback commands or status requests from a GUI 710 (off-page connector 618). The commands come in command message format and include playback commands and status requests. The remote command handler 612 processes these command messages and sends them to the DVD Navigator 614. The DVD navigator 614 operates the same as or similar to the DVD navigator 214 in FIG. 2. The DVD navigator 614, responsive to a playback command selects certain presentation data from the presentation data 114 on the DVD, like explained above for FIG. 2. The selected presentation data is sent to a network encryption module 620 from the DVD 110, encrypted with a network encryption algorithm and transmitted to communications network 520. (off-page connector 622). In addition, certain DVD navigator data, for example, command permission, CSS key, user decoder selection, is encrypted by the network encryption module 620 and sent with the encrypted presentation data. In the preferred embodiment the presentation data still has the CSS protection when sent by the server software 610. In an alternative embodiment the network encryption module 620 removes, i.e., decrypts, the CSS protection and then encrypts the presentation data with network encryption.

In an alternate embodiment of the present invention the server 610 in FIG. 6 further includes a buffer module (not shown) connected between the DVD 110 and network encryption module 620. The buffer module has a plurality of storage areas, where each storage area can hold presentation data selected from the presentation data 114 on DVD 110 by each of a plurality of clients. Hence different clients can navigate and view different presentation data from the same DVD concurrently. The command message format of the commands sent by the GUI 710 to the remote command handler 612, has the following format:

struct CommandMessage
{
struct sockaddr_in client_addr;
enum CommandCode command_code;
unsigned short datalength;
unsigned char data[COMMAND_DATA_LENGTH];
};

where the “data” field, i.e., “data[COMMAND_DATA_LENGTH]” includes command-specific data, which may be in different formats for command messages of different command codes. The command codes, i.e., “CommandCode,” include Open, Close, GetPlayBackStatus, GetTitleStatus, GetMenuStatus, GetAudioStatus, GetSPStatus, GetAngleStatus, Play, Step, Pause_On, Pause_Off, Still_Off, Stop, Resume, PrevPG_Search, TopPG_Search, NextPG_Search, Forward_Scan, Backward_Scan, PTT_Search, Time_Search, BookMark_Play, Title_Play, PTT_Play, Time_Play, Select, Activate, GoUp, Menu_Call, Button_Activate, Button_Select_and_Activate, Upper_Button_Select, Lower_Button_Select, Left_Button_Select, Right Button_Select, Menu_Language_Select, Audio_Stream_Change, SP_Stream_Change, Angle_Change, Parental_Level_Select, Parental_Country_Select, Karaoke Audio Presentation Mode Change, and Video Presentation Mode Change.

The objects associated with the above commands are given in Appendix A which is herein incorporated by reference in its entirety.

The remote command handler 612 in response to certain commands from the GUI 710 may send back a response back to the GUI 710. The response message format is:

struct ResponseMessage
{
int response_code;
unsigned short datalen;
unsigned char data[COMMAND_DATA_LEN];
};

The data field, i.e., “data[COMMAND_DATA_LEN]” includes command-specific response data, which may be in different formats for the response messages of command messages with different command codes. The response messages of get-status commands contain the data requested by clients. For example, the data format used by the response message of a “GetPlayBackStatus” command is illustrated below:

```
struct PlayBackStatus
    {
    unsigned short domain;
    unsigned short title_max;
    unsigned short title_n;
    unsigned short part_of_title_max;
    unsigned short part_of_title_n;
    unsigned short video_title_set_n;
    unsigned short program_chain_n;
    unsigned long playback_time;
    unsigned long elapse_time;
    long speed;
    unsigned short media_type;
    unsigned short playback_mode;
    unsigned short repeat_mode;
    unsigned short aspect_ratio;
    unsigned long user_operation_flag;
    };
```

The various response structures are given in Appendix A.

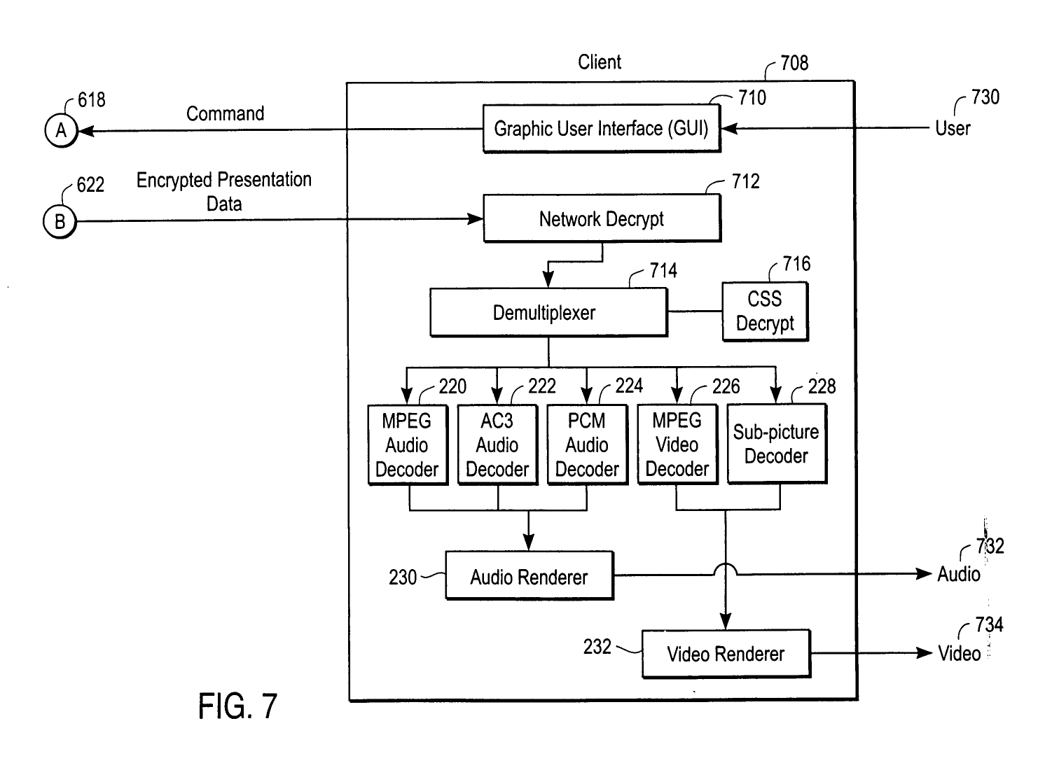

FIG. 7 is a block diagram of modules in a client computer of an embodiment of the present invention. The client software 708 sends the control and navigation playback commands or status requests to the remote command handler 612 in server software 610 (off-page connector 618) and receives encrypted presentation data from network encryption module 620 in server 610 (off-page connector 622) via communications network 520. Upon receipt of the selected encrypted presentation data the network decryption module 712 decrypts the presentation data. The network decryption module 712 also decrypts any navigation data that was sent with the presentation data. The data from the network decryption module 712 is sent to the demultiplexer 714. The demultiplexer 714 removes the CSS protection from the presentation data using the CSS decryption module 716 and the CSS key, which was part of the decrypted navigation data. The demultiplexer 714 filters out the video, audio, and sub-picture packets from the presentation data with the encoding scheme, e.g., MPEG, specified by the navigation data and sends the filtered data to the appropriate decoder modules. The decoder modules, and rederers function the same or similar to what was previously described for FIG. 2.

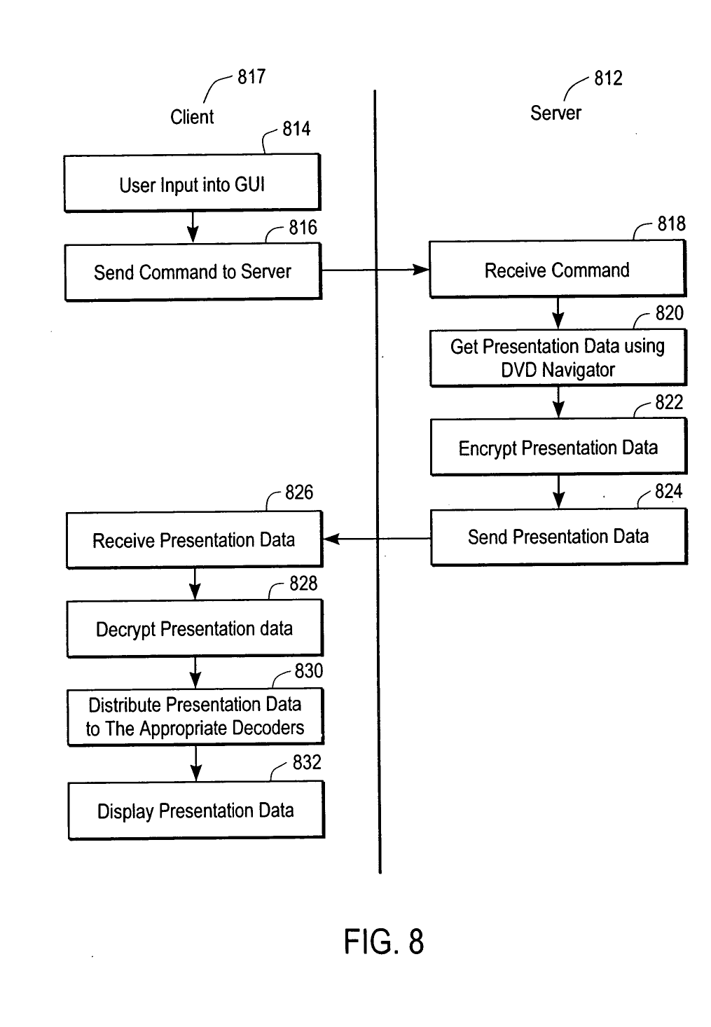

FIG. 8 is a flowchart of the remote playback process of an embodiment of the present invention. A client 810 communicates with a server 812 via a communications network 520. At step 814 the user inputs a command into GUI 710. At step 816 the command is sent to the server 812 in the form of a command message. At step 818 the remote command hander 612 receives the command message and extracts the command for use by the DVD navigator 614. At step 820 presentation data selected by the navigator is retrieved from the DVD 110. The selected presentation data is encrypted (step 822) and sent to the client 810 (step 824). At step 826 the client 810 receives the presentation data and decrypts it (step 828). The presentation data in step 828 may be decrypted twice, once for the network encryption and then for the CSS protection. An alternative step 828 would only decrypt the presentation data for the network encryption as the CSS protection would be removed at step 820. At step 830 the presentation data is sent to predetermined decoders, where the user has previously selected the decoders to be used. At step 832 the presentation data, for example, a movie, is then shown on a display screen, e.g., FIG. 3, with the accompanying audio.

Thus the user 730 at a client computer, e.g., client 524, enters his/her playback commands into GUI 710 which has a graphical display as in FIG. 4. The commands are then sent to a server with a DVD drive, e.g., server 510 with DVD drive 512, and the presentation data specified by the playback command is read from the DVD 110. The selected presentation data is returned by the server, e.g. server 510, to the client, e.g., client 524, so that the user 730 can view a DVD playback of presentation data, such as that shown in FIG. 3, on his/her computer display. At least one major advantage is that a remote user can control, navigate, and view a DVD loaded on a DVD drive at another computer.

Another embodiment of the present invention includes implementing the DVD client and server with a “peer-to-peer” approach, that allows a device to be both a client and a server. This means that the server 610 software modules in FIG. 6 and the client 708 software modules in FIG. 7 are both on one computer, so that the computer can be a server to other clients on the network and a client to another server on the network. For example, in FIG. 5, if servers 510 and 514 each have a peer-to-peer software player, the DVD 512 in the DVD drive on server 510 can be played and viewed at server 514 and the DVD 516 in the DVD drive on server 514 can be played and viewed at server 510. Thus, one advantage is that DVD's maybe shared without the need for physically exchanging the media, because computer A can control and view the DVD on computer B, while computer B controls and views the DVD on computer A.

FIG. 9 is a block diagram of a software DVD player that has both client mode and server mode. The software 910 can switch between standalone, client, and server modes at run-time. When it is in client mode, it gives commands to a remote server and streams presentation data from that server. When it finishes playing back remote presentation data and when requested by another client device, it can switch to server mode and begin serving DVD contents out of its own local DVD in its own DVD drive for the remote client.

The Peer-to-Peer player in FIG. 9 has many modules similar to FIGS. 6 and 7, and their function is not repeated in order not to obscure the invention. Note Audio decoder module 914 includes the three audio decoders of FIG. 7, e.g., 220, 222, and 224, in order to simplify the diagram. The remote command handler module 912 provides for delivering local user commands to a remote server 922 or receiving and handling requests from a remote client 920, depending on the mode (client or server). The demultiplexer 914, depending on the mode, receives remote server presentation data 924 via network interface/encryption/decryption module 918 like in FIG. 7 or gets selected presentation data from DVD 110 and sends the selected presentation data via interface/encryption/decryption module 918 to a remote client 926. The multicast module 916 allows multicasting the selected presentation data to one or more remote clients 926.

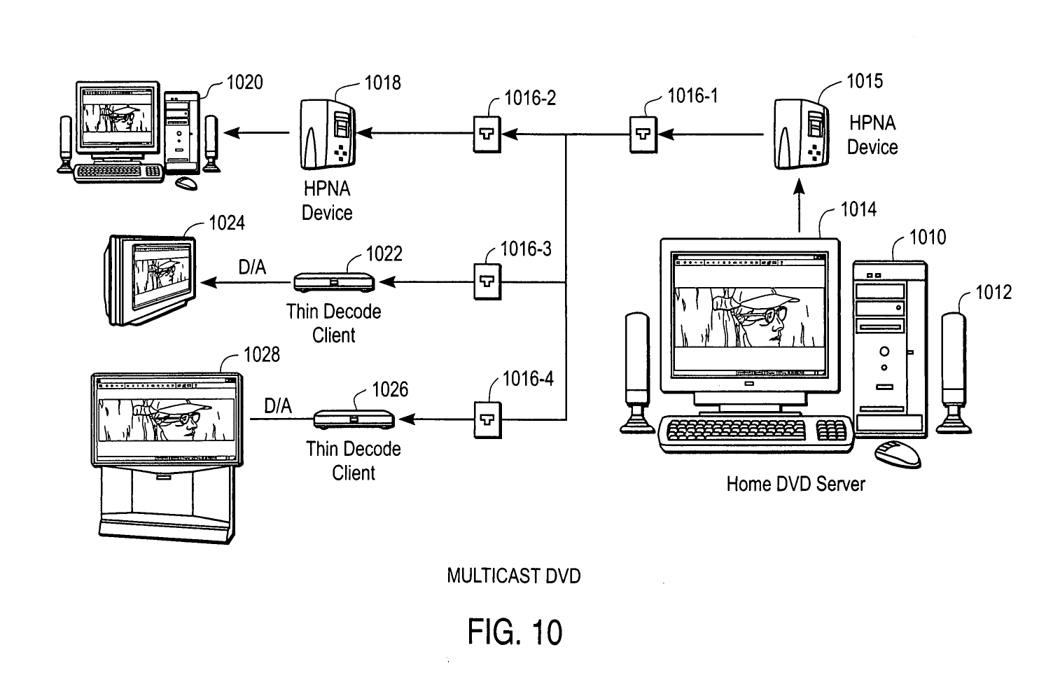

FIG. 10 is a diagram of an example home networking system in which a DVD drive is shared by multiple users in the home of an embodiment of the present invention. A Home DVD server 1010 has a DVD drive 1012. The user at the home DVD server 1010 may view the DVD on a display 1014. The home DVD server is connected to a HPNA device 1015, where HPNA is Home Phoneline Networking Alliance, an industry standard for interconnecting computers within a home using existing telephone lines and registered jacks, e.g. 1016-1, 1016-2, 1016-3, and 1016-4. HPNA device 1015 is connected to HPNA device 1018, and hence couples server computer 1010 (FIG. 6 or FIG. 9) to client computer 1020 (FIG. 7). A thin decode client, e.g., 1022 or 1026, that includes all the modules of FIG. 7 client 708, except the GUI 710, can receive the presentation data from the home DVD server 1010 and display, for example, the movie, on a TV 1024 or home theater 1028. When home DVD server 1010 has both client and server software, one option is that the DVD is controlled from the home DVD server 1010 and multicast to the other devices, e.g., client computer 1020, TV 1024, and home theater 1028.

In an alternate embodiment of the above home networking system, the home DVD server is a server device connected to one or more client devices via one or more communication links, where a link comprises, a telephone line, wireless link, cable (Cable TV or router), power line, or any combination thereof.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the invention has been described using a particular series of transactions and steps, it should be apparent to those skilled in the art that the scope of the invention is not limited to the described series of transactions and steps.

Further, while the invention has been described using a particular combination of hardware and software, it should be recognized that other combinations of hardware and software are also within the scope of the invention. The invention may be implemented only in hardware or only in software or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

1. A method for a first device remotely playing back a DVD or VCD at a second device said method comprising:
receiving information, comprising DVD or VCD presentation data, from said second device;
decoding part of said DVD or VCD presentation data by said first device; and
processing said part for display.

2. The method of claim 1 further comprising:
decrypting received information; and
demultiplexing decrypted received information before decoding.

3. The method of claim 2 wherein said demutiplexing comprises performing CSS decryption.

4. The method of claim 2 wherein said demultiplexing comprises filtering said DVD or VCD presentation data for said part.

5. The method of claim 2 further comprising sending a user command from a graphical user interface at said first device to a navigation manager operating on said second device.

6. The method of claim 1 wherein said DVD presentation data comprises presentation data without CSS protection, wherein said CSS protection was removed by said second computer system.

7. The method of claim 1 wherein said decoding part of said DVD or VCD presentation data uses a decoder type pre-selected by said user.

8. The method of claim 7 wherein said decoder type is selected from a group consisting of a MPEG decoder, an AC3 decoder, and a PCM decoder.

9. The method of claim 7 wherein said information further includes user selection of decoder type.

10. The method of claim 1 wherein said information further includes a CSS decryption key.

11. The method of claim 1 wherein said DVD or VCD presentation data includes interleaved audio and video packets.

12. A method for providing presentation data from a first computer, comprising a DVD or CD drive, to a second computer, comprising a GUI remote control, said method comprising:
receiving a command from said GUI remote control;
executing said command by a navigator module operating on said first computer, wherein said navigator module selects said presentation data; and
encrypting said presentation data before sending said presentation data to said second computer.

13. The method of claim 12 wherein said presentation data includes CSS protection.

14. The method of claim 12 wherein said GUI comprises a predetermined graphic comprising predetermined selection buttons.

15. The method of claim 12 further comprising removing said CSS protection from said presentation data before said encrypting said presentation data.

16. A system for sending presentation data from a DVD or CD drive at a server to a client, comprising:
a remote command handler for receiving a command from a graphical user interface;
a navigator module for processing said command and selecting presentation data from said DVD or CD drive; and
a network encryption module for encrypting and sending said presentation data to said client via a communications network.

17. A client system for remote playback of a DVD or VCD at a server device by a client device connected to said server device via a communications network, comprising:
a network decryption module for decrypting presentation data from said server device;
said decoder for decoding part of said decrypted presentation data; and
a display connected to said client device for displaying said part after decoding.

18. The client system of claim 17 further comprising:
a graphical user interface displayed on a client device display for receiving a command from a user.

19. The client system of claim 17 wherein said network decryption module is coupled to a Content Scrambling System (CSS) module for removing CSS protection from said presentation data.

20. A system for remote playback of a DVD, comprising:
a server device comprising: a DVD drive, DVD navigator software, and a network module for sending presentation data from said DVD drive, wherein said presentation data is selected by said DVD navigator software; and
a client device for receiving said presentation data, comprising:
a graphical user interface for accepting a playback command entered by a user to control said DVD navigator software in said server device;
a demultiplexer for distributing a part of said presentation data to a decoder; and
a display for displaying said part after decoding.

21. The system of claim 20 wherein said graphical user interface is created using predetermined user interface data at said client machine and displayed using said client computer.

22. The system of claim 20 wherein said demultiplexer is coupled to a Content Scrambling System (CSS) module for decrypting CSS protection from said presentation data.

23. A system for providing both server and client functions for playback of a DVD or VCD, comprising:
a DVD or CD drive for playback of said DVD or VCD by a local client or a remote client;
a remote command handler for receiving commands from said remote client and sending commands to a remote server;
a network interface module for receiving presentation data from said remote server; and
a multicast module for sending presentation data from said DVD or CD drive to one or more remote clients.

24. A home networking system for a user viewing on a display, connected to a client device at a first location, presentation data of a DVD or VCD loaded on a DVD or VCD drive on a server device at a second location, comprising:
a home networking device connecting a server device to said client device via a communications link; wherein said server device sends said presentation data from said DVD or VCD to said client device; and wherein said client device decodes part of said presentation data for displaying on said display.

25. The system of claim 24 wherein said client device further comprises a CSS decryption module for removing CSS protection from said presentation data.

26. The system of claim 24 wherein said communications link is selected from a group consisting of a telephone line, a TV cable, a wireless link, and a power line.

27. A method for a plurality of client devices playing back a DVD loaded in a DVD drive of a server device, comprising:
receiving a playback command from a client device of said plurality of client devices by said server device;
responsive to said playback command, retrieving presentation data from said DVD; and
multicasting said presentation data to said plurality of client devices.

28. A computer program product, comprising code stored in a computer readable medium, for providing presentation data from a first device, comprising a DVD drive, to a second device, comprising a GUI remote control, said code comprising:
code for receiving a command from said GUI remote control;
code for executing said command by a navigator module operating on said first device, wherein said navigator module selects said presentation data; and
code for encrypting said presentation data before sending said presentation data to said second device.

29. A computer program product, comprising code stored in a computer readable medium, for a first device remotely playing back a DVD at a second device, said code comprising:
code for receiving information, comprising DVD presentation data, from said second device;
code for decoding part of said DVD presentation data by said first device; and
code for processing said part for display.
